(19) United States
(12) Patent Application Publication
(10) Pub. No.: US 2026/0324671 A1
(43) Pub. Date: Oct. 22, 2026

(54) CONTAINMENT SYSTEM FOR A CONFECTIONARY MOULDING MACHINE

(71) Applicant: TNA Australia Pty Limited, Sydney Olympic Park (AU)

(72) Inventor: Morey James HAKIM, Sydney Olympic Park (AU)

(73) Assignee: TNA Australia Pty Limited, Sydney Olympic Park (AU)

(21) Appl. No.: 19/654,080

(22) Filed: Apr. 21, 2026

(30) Foreign Application Priority Data
Apr. 22, 2025 (AU) 2025901406

(51) Int. Cl. A23G 3/02

(52) U.S. Cl. CPC A23G 3/0252

(57) ABSTRACT

There is disclosed herein a containment system for a confectionery moulding machine having a hopper that is controllable to release starch to a tray in a starch dispensing area, the containment system including: at least one gate member mounted in the starch dispensing area and adapted to interact with the tray as the tray moves through starch dispensing area, the gate member being configured to move between a first position and a second position, wherein in the second position, a lower face of the gate member is in contact with and level with an upper face of the tray, and wherein contact between the lower face of the gate member and the upper face of the tray creates a seal therebetween.

### CROSS-REFERENCE TO RELATED APPLICATION

This application claims priority to Australian Patent Application No. 2025901406, filed on 22 Apr. 2025. The entire disclosure of Australian Patent Application No. 2025901406 is hereby incorporated by reference in its entirety and for all purposes.

### FIELD

The present disclosure generally relates to confectionery moulding machines, and more particularly, but not exclusively, to containment systems for starch filling of confectionery moulding machines.

### BACKGROUND

In the production of confectionery items, the operation of a confectionery moulding machine (starch mogul) typically involves the filling of confectionery trays with moulding starch and forming impressions in the starch. The impressions provide a plurality of cavities, and liquid is delivered to the cavities to form the confectionery when set.

Industry standards involve flood-filling the trays with moulding starch to ensure complete filling without air pockets, followed by applying compressed air to the edges of the tray to clean or remove the excess starch from the edges of the tray. However, the use of compressed air to clean the tray edges causes displaced starch to become airborne, and the presence of airborne starch results in contamination of surrounding mechanisms and trays, and also increases the risk of hazardous and explosive conditions. The use of compressed air also increases the operation costs of the confectionery moulding machine.

### SUMMARY

It is an object of the present invention to substantially overcome, or at least ameliorate, one or more of the disadvantages of existing arrangements, or at least provide a useful alternative to existing arrangements.

In accordance with one aspect, there is provided a containment system for a confectionery moulding machine having a hopper that is controllable to release starch to a tray in a starch dispensing area, the containment system including:
at least one gate member mounted in the starch dispensing area and adapted to interact with the tray as the tray moves through starch dispensing area, the gate member being configured to move between a first position and a second position,
wherein in the second position, a lower face of the gate member is in contact with and level with an upper face of the tray, and
wherein contact between the lower face of the gate member and the upper face of the tray creates a seal therebetween.

In one or more embodiments, the at least one gate member is adapted to apply a downward force in the second position so as to maintain the seal between the lower face of the gate member and the upper face of the tray.

In one or more embodiments, the lower face of the gate member is below an upper face of the tray in the first position.

In one or more embodiments, the at least one gate member is biased towards the first position.

In one or more embodiments, movement of the gate member between the first position and the second position is caused by the tray pushing on the gate member.

In one or more the lower face of the gate member is above an upper face of the tray in the first position.

In one or more embodiments, movement of the gate member between the first position and the second position is independently actuated or controlled.

In one or more embodiments, the gate member is independently actuated or controlled by one or more actuators or motors. The one or more actuators may be a pneumatic actuator.

In one or more embodiments, the at least one gate member has a width that is larger than a width of the tray.

In one or more embodiments, the tray has a short edge providing a nesting area of the tray, and the at least one gate member has a depth that is larger than a depth of the short edge of the tray.

In one or more embodiments, the at least one gate member includes a ramp portion that contacts or engages a leading edge of the tray as the tray travels into the starch dispensing area.

In one or more embodiments, the containment system includes a pair of the gate members, being a first gate member adapted to interact with a first side of the tray and a second gate member adapted to interact with a second side of the tray.

In one or more embodiments, the containment system further includes a scraper or leveller to scrape or level the starch in the tray.

In accordance with another aspect, there is provided a containment system for a confectionery moulding machine having a hopper that is controllable to release starch to a tray in a starch dispensing area, the system containment including:
at least one gate member mounted in the starch dispensing area and adapted to interact with the tray as the tray moves through starch dispensing area,
the gate member being configured to move between a lowered position and a raised position, wherein in the lowered position, a lower face of the gate member is below an upper face of the tray and in the raised position, the lower face of the gate member is in contact with and level with the upper face of the tray, and wherein contact between the lower face of the gate member and the upper face of the tray creates a seal therebetween.

In one or more embodiments, the at least one gate member is adapted to apply a downward force in the raised position so as to maintain the seal between the lower face of the gate member and the upper face of the tray.

In one or more embodiments, the at least one gate member is biased towards the lowered position.

In one or more embodiments, movement of the gate member between the lowered position and the raised position is caused by the tray pushing on the gate member.

In one or more embodiments, the at least one gate member has a width that is larger than a width of the tray.

In one or more embodiments, the tray has a short edge providing a nesting area of the tray, and the at least one gate member has a depth that is larger than a depth of the short edge of the tray.

In one or more embodiments, the at least one gate member includes a ramp portion that contacts or engages a leading edge of the tray as the tray travels into the starch dispensing area.

In one or more embodiments, the containment system includes a pair of the gate members, being a first gate member adapted to interact with a first side of the tray and a second gate member adapted to interact with a second side of the tray.

In accordance with another aspect, there is provided a containment system for a confectionery moulding machine having a hopper that is controllable to release starch to a tray in a starch dispensing area, the system containment including:
at least one gate member mounted in the starch dispensing area and adapted to interact with the tray as the tray moves through starch dispensing area,
the gate member being configured to move between a raised position and a lowered position, wherein in the raised position, a lower face of the gate member is above an upper face of the tray and in the lowered position, the lower face of the gate member is in contact with and level with the upper face of the tray, and wherein contact between the lower face of the gate member and the upper face of the tray creates a seal therebetween.

In one or more embodiments, the at least one gate member is adapted to apply a downward force in the lowered position so as to maintain the seal between the lower face of the gate member and the upper face of the tray.

In one or more embodiments, the containment system further includes a motor to drive movement of the at least one gate member between the raised position and the lowered position.

In one or more embodiments, movement of the gate member between the raised position and the lowered position is independently actuated.

In one or more embodiments, the gate member is independently actuated by one or more pneumatic actuators.

In one or more embodiments, the at least one gate member has a width that is larger than a width of the tray.

In one or more embodiments, the tray has a short edge providing a nesting area of the tray, and the at least one gate member has a depth that is larger than a depth of the short edge of the tray.

In one or more embodiments, the containment system includes a pair of the gate members, being a first gate member adapted to interact with a first side of the tray and a second gate member adapted to interact with a second side of the tray.

### BRIEF DESCRIPTION OF THE DRAWINGS

For a more complete understanding of the present invention, exemplary embodiments of the invention are explained in more detail in the following description with reference to the accompanying drawing figures, in which like reference signs designate like parts and in which:

FIGS. 1-10 are schematic side views of a containment system according to one embodiment, including enlarged views of various sections of the containment system, and showing various stages of a tray movement relative to the containment system;

FIG. 11 is a further schematic side view of the containment system shown in FIGS. 1-10;

FIG. 12 is a schematic end cross-sectional view of the containment system shown in FIG. 11;

FIG. 13 is a schematic end view of the containment system shown in FIG. 11;

FIG. 14 is an enlarged view of a section of the containment system shown in FIG. 13; and

FIGS. 15A-19 are schematic side views of a containment system according to another embodiment, including enlarged views of various sections of the containment system, and showing various stages of a tray movement relative to the containment system.

### DETAILED DESCRIPTION

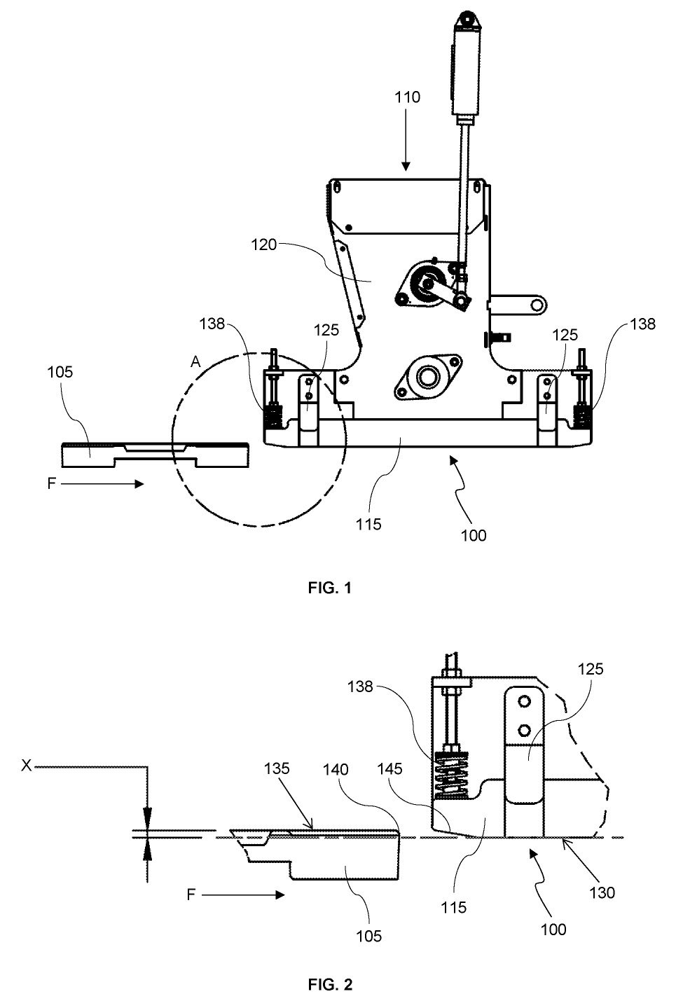

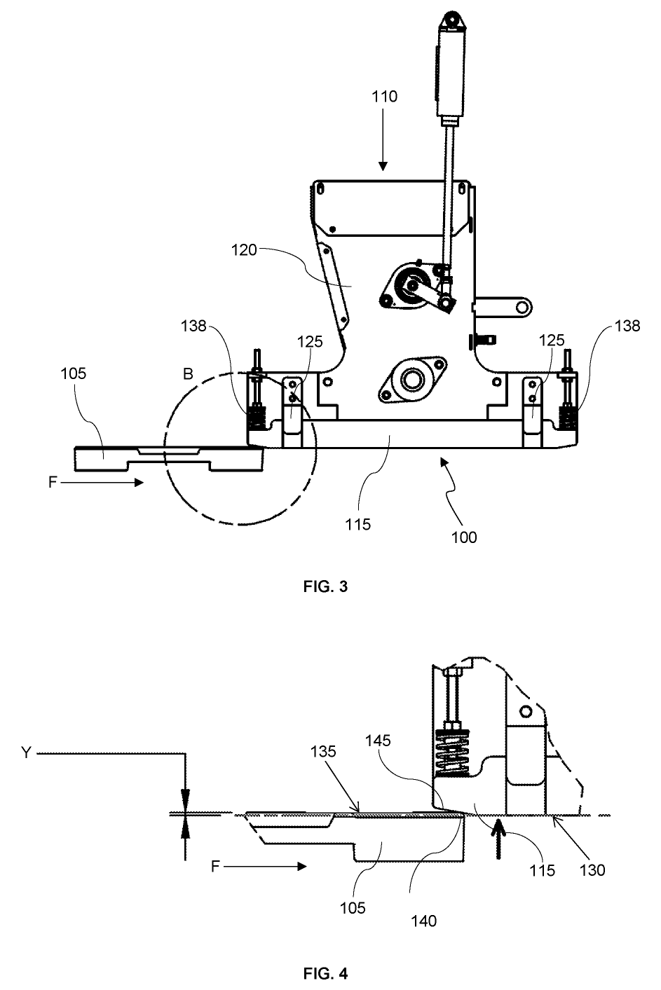

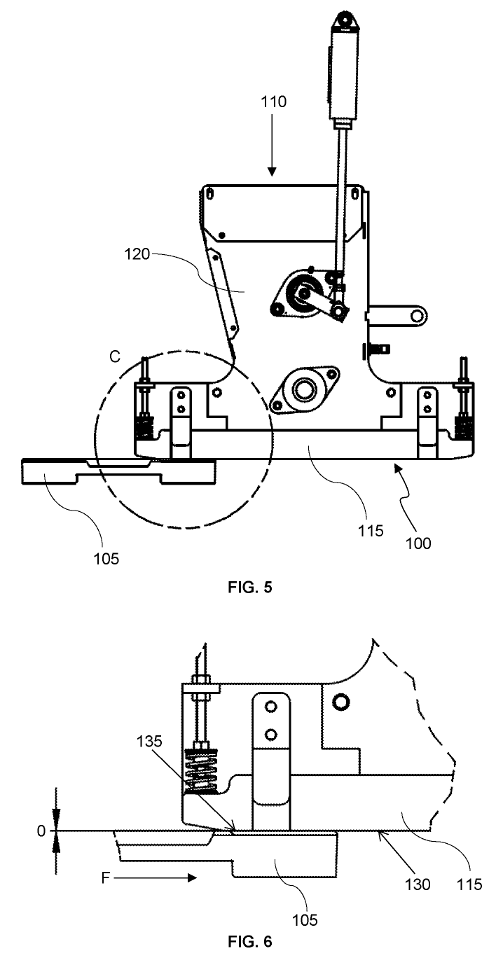

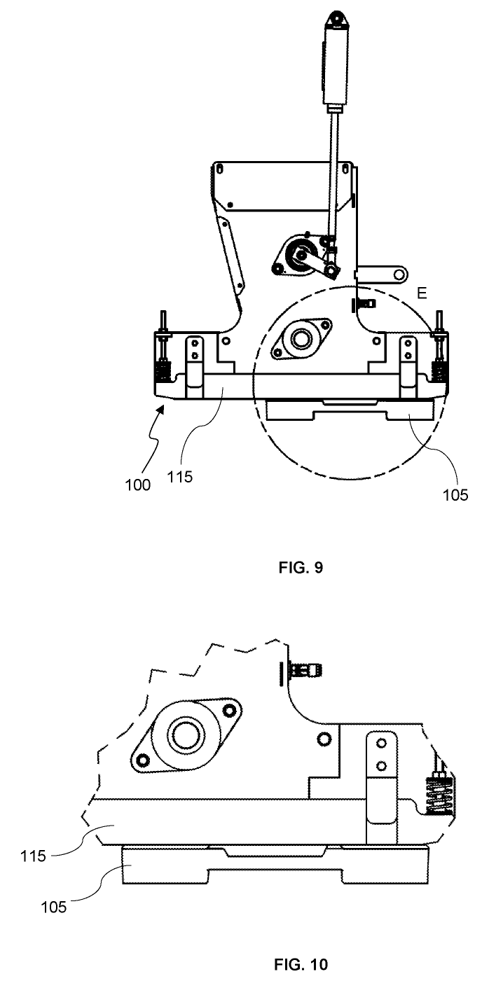

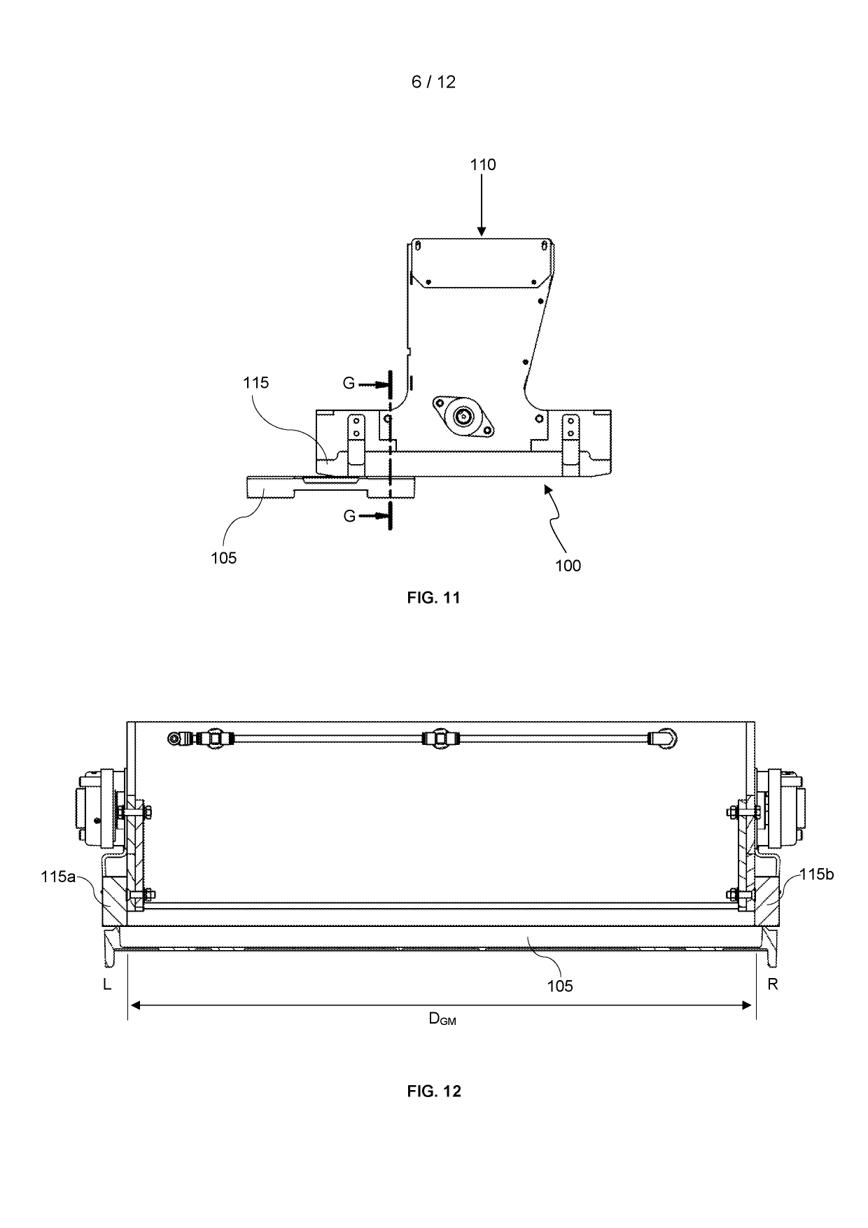

In FIGS. 1-14 of the accompanying drawings, there is schematically depicted an embodiment of a containment system or assembly 100 for a confectionery moulding machine. The containment system 100 is incorporated in the confectionery moulding machine, and during a typical operation of the machine, a plurality of trays (confectionery moulding trays) 105 are moved around (indexed) to accommodate various stages of a confectionery moulding process. One such process is a starch filling process, as will be described further below. For the purposes of this specification, only a single tray 105 is described and shown in the drawings, which also exemplify the movement of the tray as it interacts with the containment system 100. It will be understood that the containment system 100 may interact with any number of trays 105 that are moved around the confectionery moulding machine, and the trays 105 may have dimensions that vary according to the requirements of the confectionery moulding process.

The containment system 100 in the depicted embodiment is located in or around a starch dispensing area of the confectionery moulding machine. In this starch dispensing area, a hopper 110 containing moulding starch is controlled to release an amount of moulding starch into an empty tray 105 disposed below the hopper 110, so as to fill the tray 105 with starch. The containment system 100 is configured to interact with the empty tray 105 as it moves through the starch dispensing area (e.g. in a forward or downstream direction along arrow F). For the purposes of this specification, it is understood that the tray 105 moves between an upstream position and a downstream position relative to the containment system 100. In the upstream position, the tray 105 is empty and is approaching the starch dispensing area and in the downstream position, the tray 105 is filled and is leaving the starch dispensing area. In between the downstream and upstream positions, i.e. when the tray 105 is in a desired position for filling, the tray 105 is in a filling position. It will be understood that screeding/scraping/levelling of the starch in the tray 105 also occurs in this starch dispensing area.

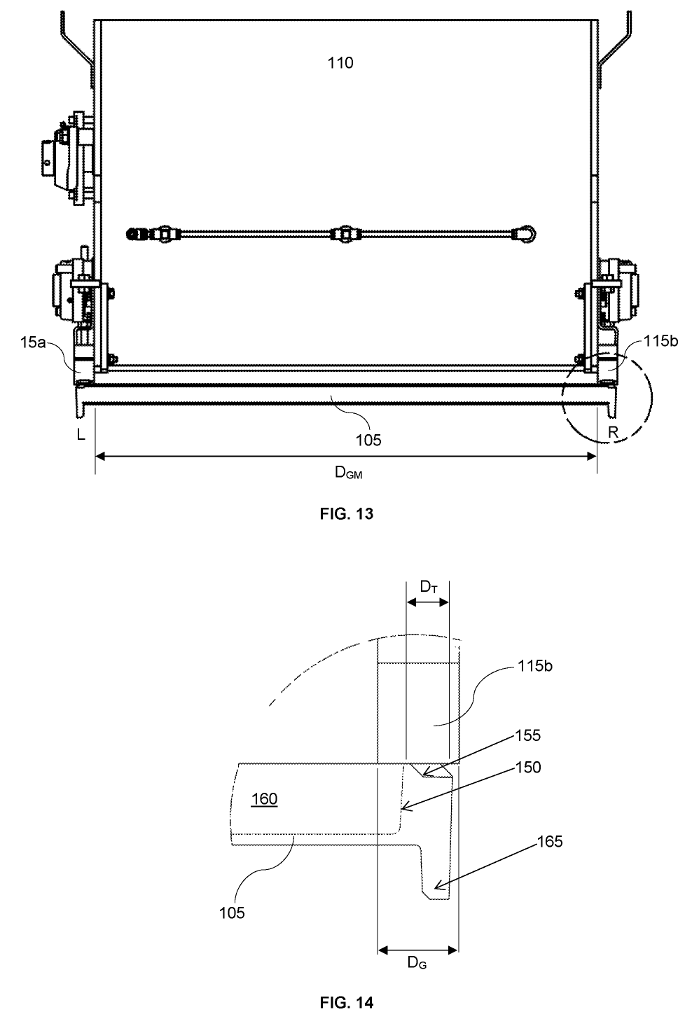

In the depicted embodiment, the containment system 100 includes a pair of barrier or gate members 115. In the interest of clarity, only one of the gate members 115 is visible in FIGS. 1-10 (being side views of the containment system 100). An illustration of the pair of gate members 115 (identified as a first gate member 115a and a second gate member 115b) is shown in FIGS. 12 and 13 (being sectional/end views of the containment system 100). The first gate member 115a may alternatively be referred to as a left side gate member and the second gate member 115b may alternatively be referred to as a right side gate member, with the left and right sides being relative to the forward direction of travel of the tray 105 as it moves through the starch dispensing area. Accordingly, it will be understood that the first or left side gate member 115a may interact with a left side L of the tray 105 and the second or right side gate member 115b may interact with a right side R of the tray 105. The first and second gate members 115a, 115b may be spaced by a distance D_{GM}.

Each gate member 115 may be mounted to the hopper 110 or a component/assembly associated with the hopper 110. In a preferred form, each gate member 115 is mounted so as to be moveable between a raised position and a lowered position with respect to the hopper 110, as will be described further below. In the example shown, each gate member 115 is mounted to a frame or side wall 120 of the hopper 110. A pair of mounting brackets 125 may be provided to facilitate the connection between the gate member 115 and the frame or side wall 120 of the hopper 110. It will, however, be appreciated that in other embodiments (not shown), each gate member 115 may otherwise be mounted at or to any other suitable location or component of the confectionery moulding machine that allows the gate member 115 to interact with the tray 105, and other mechanisms for mounting the gate member 115 to the hopper 110 may be implemented.

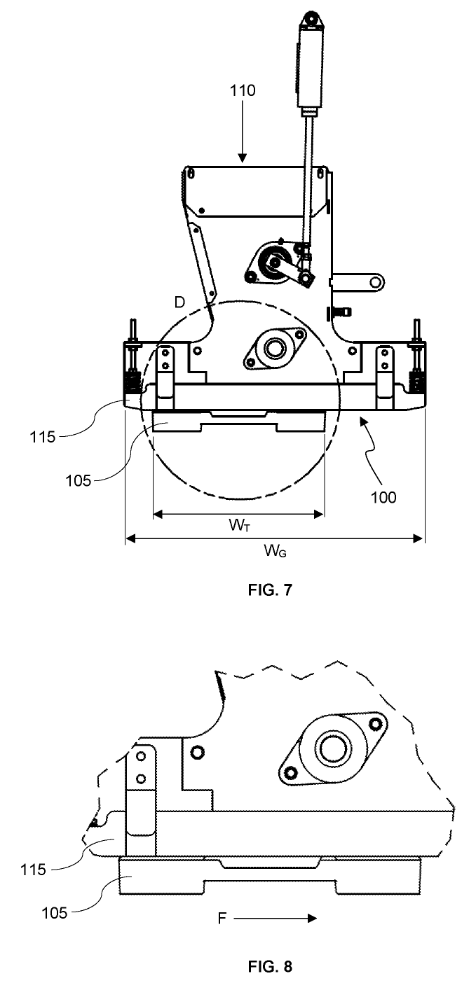

Each gate member 115 may have a width W_{G} that corresponds to a width W_{T} of the tray 105 and in one preferred form, the width W_{G} of the gate member 115 is larger than the width W_{T} of the tray 105 (see FIG. 7). It is understood that in typical hopper arrangements of a confectionary moulding machine, the width of the hopper does not span the entire width of a tray and therefore, in such arrangements, the moulding starch that is released into the tray located below the hopper will be susceptible to spilling over the sides of the tray where gaps are present. The configuration of the gate members 115 in this embodiment of the containment system 100 may therefore provide a barrier or cover to at least contain the moulding starch substantially within the confines of a starch filling zone of the tray 105, thereby reducing or altogether eliminating the spilling of moulding starch over the sides of the tray 105. This may at least prevent the buildup of excess starch on the sides/edges of the tray 105, which would otherwise hinder proper tray stacking.

Additionally, each gate member 115 is moveable between a lowered or free position as shown in FIG. 2, whereby a lower edge or face 130 of the gate member 115 is below an upper edge or face 135 of the tray 105 by a distance X, and a raised or sealing position as shown in FIG. 6, whereby the lower face 130 of the gate member 115 is level with the upper face 135 of the tray 105. In the sealing position, contact between the lower face 130 of the gate member 115 and the upper face 135 of the tray 105a may create a seal therebetween. In other words, a sealed area may be formed within the tray 105a. A downward force may be applied from the gate member 115 to the tray 105 to create or maintain the seal between the lower face 130 of the gate member 115 and the upper face 135 of the tray 105. As such, the lower edge or face 130 of the gate member 115 may also be referred to as a sealing face of the gate member 115. The downward force may be from the weight of the gate member 115 itself acting upon the tray 105, or from biasing the gate member 115 towards the lowered or free position by way of one or more springs 138 or other biasing mechanisms. Alternatively, and as will be described below, the movement of the gate member (and thereby the downward force) may be from the independent control of the movement of the gate member 115 towards the raised or sealing position. In the sealing position, and as best shown in FIGS. 7 and 8, the gate member 115 (having a width W_{G} that is larger than a width W_{T} of the tray 105) may cover the entire width W_{T} of the tray 105, and thereby also seal the entire width W_{T} of the tray 105.

Movement of the gate member 115 between the lowered or free position and the raised or sealing position may be caused by the contact or interaction between the gate member 115 and the tray 105 as the tray 105 moves through the containment system 100. For example, in the depicted embodiment, as the tray 105 moves in the forward or downstream direction F, a leading edge 140 of the tray 105 contacts or engages the gate member 115 and travels along a ramp portion 145 of the gate member 115, and this contact pushes the gate member 115 upwards into the raised or sealing position. As the leading edge 140 of the tray 105 travels along the ramp portion 145 of the gate member 115, the lower face 130 of the gate member 115 may be below the upper face 135 of the tray by a distance Y (see FIG. 4).

As noted above, the gate member 115 moves into the raised or sealing position as the tray 105 moves in the forward or downstream direction F, and the raised or sealing position is best shown in FIGS. 7 and 8. It will be understood that the seal between the lower face 130 of the gate member 115 and the upper face 135 of the tray 105 is maintained as the tray 105 moves in the forward or downstream direction F, into the filling position, and as the tray 105 is being filled with moulding starch from the hopper 110. Accordingly, it will be appreciated that the arrangement of the gate member 115 may thereby prevent or altogether eliminate the spilling of moulding starch over the sides of the tray 105 as the tray 105 is being filled. Additionally, the arrangement of the gate member 115 may also prevent or altogether eliminate the spilling of moulding starch over the sides of the tray 105 as the tray 105 is being screeded, levelled, or scraped. This arrangement may therefore reduce or eliminate the need to clean the tray 105 (particularly the sides of the tray 105, which form the nesting area of the trays as will be discussed further below) following filling, for example by using costly compressed air arrangements. The arrangement of the gate member 115 may also protect the sides or short edges of the tray 105 during the scraping or levelling process. To this end, it will be appreciated that the containment system 100 may optionally be provided with a scraper or leveller to scrape or level the starch in the tray 105, generally within the sealed area.

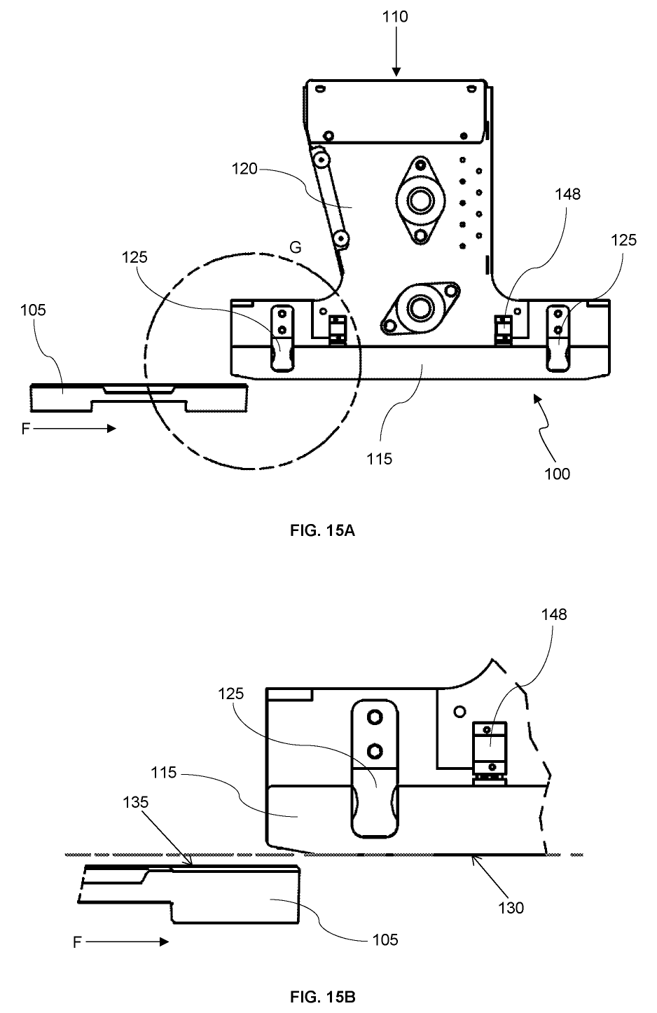

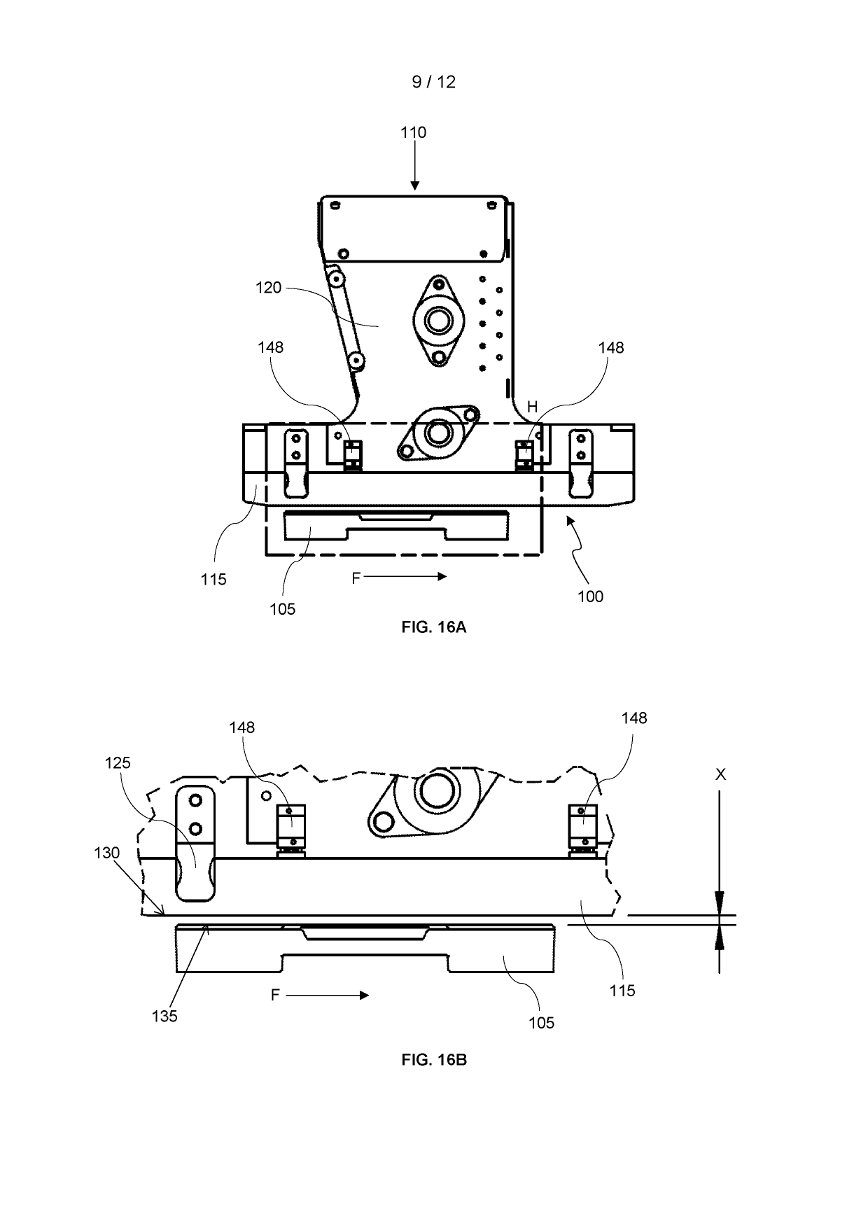

Additionally or alternatively, and as best shown in FIGS. 15A-19, movement of the gate member 115 between a first position and a second position may be independently actuated or controlled by one or more actuators or motor 148 (i.e. without relying on the movement of the tray 105 to in turn cause movement of the gate member 115). As such, the gate member 115 may be movable relative to the hopper 110 instead of being moved by the tray 105. For example, the gate member 115 may be operatively associated with one or more motors, which may be controlled to drive movement of the gate member 115 between the two positions. In other examples, the gate member 115 may be operatively associated with one or more pneumatic actuators, which may be controlled to drive movement of the gate member 115 between the two positions. In some embodiments, the containment system 100 may include one or more sensors to detect the absence of presence of a tray and/or the various positions of the tray 105 as it moves between an upstream position and a downstream position. In such embodiments, the containment system 100 may include a processor that is operatively associated with the one or more actuators or motors 148 and the one or more sensors. The processor may be configured to control the operation of the one or more actuators or motors 148 based on the position of the tray 105 detected by the one or more sensors.

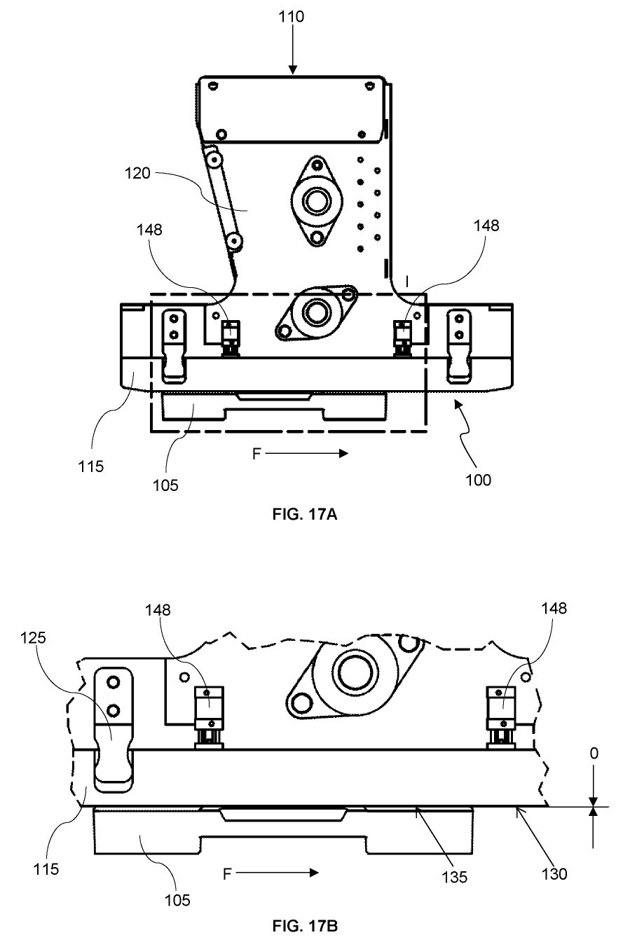

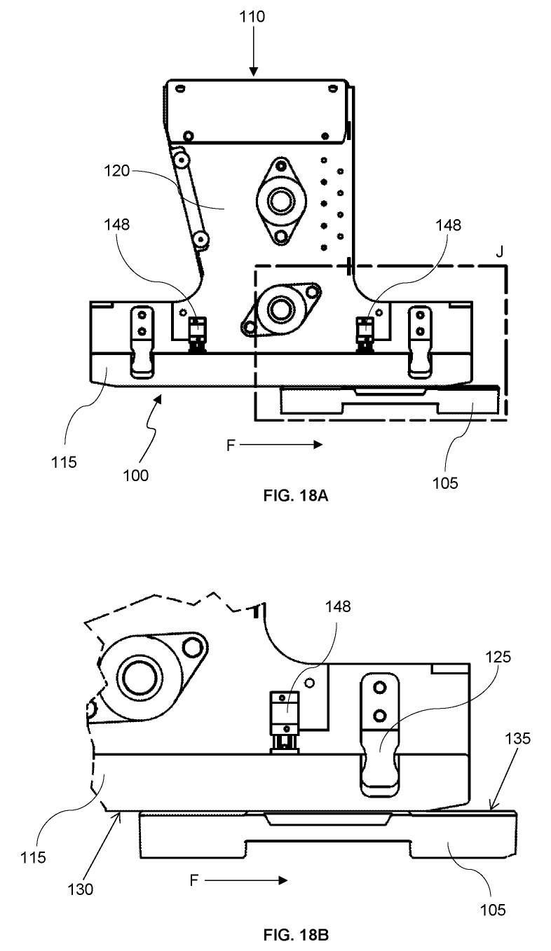

In embodiments whereby movement of the gate member 115 between the first position and the second position is independently actuated or controlled, the first position of the gate member 115 may be an upper or free position (for example, as shown in FIGS. 15A, 15B, 16A and 16B) and the second position of the gate member 115 may be a lowered or sealing position (for example, as shown in FIGS. 17A, 17B, 18A, 18B and 19). In the upper or free position (e.g. FIGS. 15A, 15B, 16A and 16B), the lower face 130 of the gate member 115 may be above the upper face 135 of the tray 105 by a distance X. In the lowered or sealing position (e.g. FIGS. 17A, 17B, 18A, 18B and 19), the lower face 130 of the gate member 115 may be level with the upper face 135 of the tray 105. In the upper or free position, the lower face 130 of the gate member 115 may also be located closer to an upper edge of the hopper 110 (relative to when the gate member 115 is in the lowered or sealing position). The actuator or motor 148 may be controlled to drive movement of the gate member 115 from the upper or free position downwardly into the lowered or sealing position (e.g. FIGS. 17A, 17B, 18A and 18B).

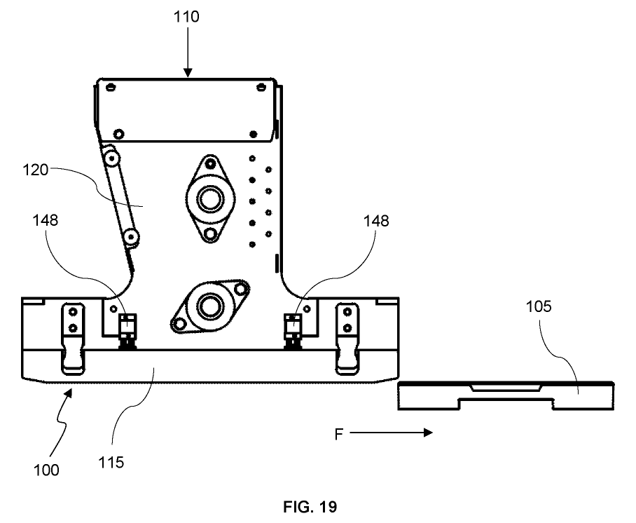

In the example shown in FIGS. 15A, 15B, 16A and 16B, the gate member 115 is held in the upper or free position as the tray 105 moves in the forward or downstream direction F, and as the containment system 100 waits for the tray 105 to move into the filling position. In the example shown in FIGS. 17A and 17B, the tray 105 is in the filling position (as detected by the one or more sensors) and the gate member 115 is moved into the lowered or sealing position. In this lowered or sealing position, the gate member 115 contacts the tray 105 and applies a downward force so as to create and maintain a seal between the lower face 130 of the gate member 115 and the upper face 135 of the tray 105. As discussed above, in a preferred form, the seal between the lower face 130 of the gate member 115 and the upper face 135 of the tray 105 is maintained as the tray 105 moves in the forward or downstream direction F and as the tray 105 is being filled with moulding starch from the hopper 110 (e.g. as shown in FIGS. 18A and 18B). Once the tray 105 has been filled and has moved further downstream away from the filling position, the one or more sensors may detect whether another tray is present upstream. If another tray is not detected, the gate member 115 may be moved back into the upper or free position. If another tray is detected, the gate member 115 may remain in the lowered or sealing position for the next cycle (e.g. as shown in FIG. 19).

Referring to FIG. 14, the interaction between the gate member 115 (identified as the second or right side gate member 115b) and the tray 105 is shown in detail. In this Figure, an internal portion or face 150 of the tray 105 is shown, along with a short edge 155 of the tray 105. The internal portion or face 150 of the tray surrounds a starch filling zone 160 of the tray 105. The short edge 155 of the tray 105 is understood to define a side of the tray, and also provides a nesting area of tray 105 so as to allow multiple trays 105 to be stacked on top of one another. For example, each tray 105 may have a lower support portion 165 on each of the sides that engages the short edge 155 on a respective side of another tray 105 located below.

As can be seen in FIG. 14, the gate member 115 may have a depth D_{G} that is larger than the depth D_{T} of the short edge 155 of the tray 105. Accordingly, the gate member 115 may project past the short edge 155 of the tray 105 so as to ensure a seal in case of tray alignment and/or to accommodate varying tray dimensions.

Various forms of the containment system described above may have one or more of the following advantages. The arrangement of the containment system described above may at least ensure that the sides or nesting areas of the trays remain substantially free of starch as the trays pass through the starch dispensing area. With a clean nesting area, the trays can be stacked properly, which may in turn reduce downtime in the confectionary moulding process as a result of machine crashes. The arrangement of the containment system described above may also at least provide a cost-effective alternative to the use of expensive compressed air arrangements to clean or remove the excess starch from the edges of the tray. By avoiding compressed air usage, the presence of displaced airborne starch (and likelihood of contamination and hazardous/explosive conditions) may also be reduced. Additionally, the risk of contaminating the surrounding mechanisms or equipment or nearby trays with displaced airborne starch may also be reduced. This may at least extend the lifespan of the surrounding mechanisms or equipment, and also keep nearby trays clean.

Although specific embodiments of the invention are illustrated and described herein, it will be appreciated by those of ordinary skill in the art that a variety of alternative and/or equivalent implementations exist. It should be appreciated that the exemplary embodiment or exemplary embodiments are examples only and are not intended to limit the scope, applicability, or configuration in any way. Rather, the foregoing summary and detailed description will provide those skilled in the art with a convenient road map for implementing at least one exemplary embodiment, it being understood that various changes may be made in the function and arrangement of elements described in an exemplary embodiment without departing from the scope as set forth in the appended claims and their legal equivalents. Generally, this application is intended to cover any adaptations or variations of the specific embodiments discussed herein.

It will also be appreciated that in this document the terms “comprise”, “comprising”, “include”, “including”, “contain”, “containing”, “have”, “having”, and any variations thereof, are intended to be understood in an inclusive (i.e. non-exclusive) sense, such that the process, method, device, apparatus or system described herein is not limited to those features or parts or elements or steps recited but may include other elements, features, parts or steps not expressly

listed or inherent to such process, method, article, or apparatus. Furthermore, the terms “a” and “an” used herein are intended to be understood as meaning one or more unless explicitly stated otherwise. Moreover, the terms “first”, “second”, etc. are used merely as labels, and are not intended to impose numerical requirements on or to establish a certain ranking of importance of their objects.

1. A containment system for a confectionery moulding machine having a hopper that is controllable to release starch to a tray in a starch dispensing area, the containment system including:
at least one gate member mounted in the starch dispensing area and adapted to interact with the tray as the tray moves through starch dispensing area,
the gate member being configured to move between a first position and a second position, wherein in the second position, a lower face of the gate member is in contact with and level with an upper face of the tray, and wherein contact between the lower face of the gate member and the upper face of the tray creates a seal therebetween.

2. The containment system according to claim 1, wherein the at least one gate member is adapted to apply a downward force in the second position so as to maintain the seal between the lower face of the gate member and the upper face of the tray.

3. The containment system according to claim 1, wherein the lower face of the gate member is below an upper face of the tray in the first position.

4. The containment system according to claim 1, wherein the at least one gate member is biased towards the first position.

5. The containment system according to claim 1, wherein movement of the gate member between the first position and the second position is caused by the tray pushing on the gate member.

6. The containment system according to claim 1, wherein the lower face of the gate member is above an upper face of the tray in the first position.

7. The containment system according to claim 6, wherein movement of the gate member between the first position and the second position is independently actuated or controlled.

8. The containment system according to claim 7, wherein the gate member is independently actuated or controlled by one or more actuators or motors.

9. The containment system according to claim 8, wherein the one or more actuators is a pneumatic actuator.

10. The containment system according to claim 1, wherein the at least one gate member has a width that is larger than a width of the tray.

11. The containment system according to claim 1, wherein the tray has a short edge providing a nesting area of the tray, and the at least one gate member has a depth that is larger than a depth of the short edge of the tray.

12. The containment system according to claim 1, wherein the at least one gate member includes a ramp portion that contacts or engages a leading edge of the tray as the tray travels into the starch dispensing area.

13. The containment system according to claim 1, wherein the containment system includes a pair of the gate members, being a first gate member adapted to interact with a first side of the tray and a second gate member adapted to interact with a second side of the tray.

14. The containment system according to claim 1, further including a scraper or leveller to scrape or level the starch in the tray.

15. A containment system for a confectionery moulding machine having a hopper that is controllable to release starch to a tray in a starch dispensing area, the system containment including:
at least one gate member mounted in the starch dispensing area and adapted to interact with the tray as the tray moves through starch dispensing area,
the gate member being configured to move between a lowered position and a raised position, wherein in the lowered position, a lower face of the gate member is below an upper face of the tray and in the raised position, the lower face of the gate member is in contact with and level with the upper face of the tray, and wherein contact between the lower face of the gate member and the upper face of the tray creates a seal therebetween.

16. The containment system according to claim 15, wherein the at least one gate member is adapted to apply a downward force in the raised position so as to maintain the seal between the lower face of the gate member and the upper face of the tray.

17. The containment system according to claim 15, wherein the at least one gate member is biased towards the first position.

18. A containment system for a confectionery moulding machine having a hopper that is controllable to release starch to a tray in a starch dispensing area, the system containment including:
at least one gate member mounted in the starch dispensing area and adapted to interact with the tray as the tray moves through starch dispensing area,
the gate member being configured to move between a raised position and a lowered position, wherein in the raised position, a lower face of the gate member is above an upper face of the tray and in the lowered position, the lower face of the gate member is in contact with and level with the upper face of the tray, and wherein contact between the lower face of the gate member and the upper face of the tray creates a seal therebetween.

19. The containment system according to claim 18, wherein the at least one gate member is adapted to apply a downward force in the lowered position so as to maintain the seal between the lower face of the gate member and the upper face of the tray.

20. The containment system according to claim 18, further including a motor to drive movement of the at least one gate member between the raised position and the lowered position.
